(19) United States
(12) Patent Application Publication
(10) Pub. No.: US 2017/0200205 A1
(43) Pub. Date: Jul. 13, 2017

(54) METHOD AND SYSTEM FOR ANALYZING USER REVIEWS

(71) Applicant: Medallia, Inc., Palo Alto, CA (US)

(72) Inventors: Juan J. Liu, Cupertino, CA (US); Ji Fang, Mountain View, CA (US); Sunjay Dodani, San Francisco, CA (US)

(73) Assignee: Medallia, Inc., Palo Alto, CA (US)

(21) Appl. No.: 14/993,021

(22) Filed: Jan. 11, 2016

(51) Int. Cl. G06Q 30/02; G06N 99/00; G06Q 10/06

(52) U.S. Cl. CPC G06Q 30/0282; G06Q 10/067; G06N 99/005

(57) ABSTRACT

One embodiment provides a system that facilitates detects and analyzes surprises in user reviews. During operation, the system stores, in a storage device, a plurality of user reviews. A user review includes a recommend score indicating a likelihood of recommending, and one or more feature values indicating user opinions about features in the user review. The system determines a first user review from the plurality of user reviews to be a first surprise in response to detecting a discrepancy between a recommend score and feature values of the first user review. The system then performs a text analysis on the first surprise to discover impactful features in the surprise.

### BACKGROUND

Field

This disclosure is generally related to user review analysis. More specifically, this disclosure is related to a method and system for identifying and analyzing surprises in user reviews.

Related Art

With the advancement of the computer and network technologies, various operations performed by users from different applications lead to extensive use of web services. This proliferation of the Internet and Internet-based user activity continues to create a vast amount of digital content. For example, multiple users may concurrently provide reviews (e.g., fill out surveys) about a business entity via different applications, such as mobile applications running on different platforms, as well as web-interfaces running on different browsers in different operating systems. Furthermore, users may also use different social media outlets to express their reviews about the business entity.

An application server for the business entity may store the reviews in a local storage device. A large number of users providing reviews can lead to a large quantity of data for the application server, which may not be possible for humans to identify and process. As a result, different data mining technique can be applied to obtain overall insight into the user reviews. However, these data mining techniques typically focus on mainstream features. As a result, these data mining techniques may fail to capture discrepancies in user reviews (e.g., positive opinion about that mainstream feature but a negative overall opinion).

Although a number of methods are available for review analysis, some problems still remain in analysis of discrepancy in user reviews.

### SUMMARY

One embodiment provides a system that detects and analyzes surprises in user reviews. During operation, the system stores, in a storage device, a plurality of user reviews. A user review includes a recommend score indicating a likelihood of recommending, and one or more feature values indicating opinions about individual features in the user review. The system determines a first user review from the plurality of user reviews to be a first surprise in response to detecting a discrepancy between a recommend score and feature values of the first user review. The system then performs a text analysis on the first surprise to discover impactful features in the surprise.

In a variation on this embodiment, the system identifies the impactful features based on the respective importance of features of a respective user review in the plurality of user reviews. The system trains a prediction model to predict a recommend score based on feature values of the identified impactful features.

In a further variation, the system determines the first surprise by determining whether a predicted recommend score deviates from the recommend score of the first user review.

In a further variation, prior to identifying the impactful features, the system fills in missing values of features of a respective user review in the plurality of user reviews.

In a variation on this embodiment, the system identifies a plurality of surprises from the plurality of user reviews. The system clusters synonymous words in the identified surprises into a word cluster, and associates the word cluster and reviews comprising the synonymous words with a corresponding meaningful feature.

In a further variation, the system determines a sentiment category for the feature. The sentiment category is one of: positive, negative, no opinion, and mixed opinion.

In a further variation, the system displays in a presentation interface one or more surprises associated with the feature in response to a user selecting the feature in the presentation interface.

In a variation on this embodiment, the system determines one or more clusters of user reviews from the plurality of user reviews by grouping the user reviews with similar feature values. The system then identifies the outlier user reviews, which deviate significantly from the determined clusters, as the surprises.

### BRIEF DESCRIPTION OF THE FIGURES

FIG. 1A illustrates an exemplary surprise analysis system, in accordance with an embodiment of the present invention.

FIG. 1B illustrates exemplary components of a surprise analysis system, in accordance with an embodiment of the present invention.

FIG. 2 presents a flowchart illustrating a method for surprise analysis in user reviews, in accordance with an embodiment of the present invention.

FIG. 3A illustrates an exemplary surprise detection, in accordance with an embodiment of the present invention.

FIG. 3B presents a flowchart illustrating a method for surprise detection in a review, in accordance with an embodiment of the present invention.

FIG. 4A presents a flowchart illustrating a method for text analysis of surprises in user reviews, in accordance with an embodiment of the present invention.

FIG. 4B presents a flowchart illustrating a method for feature discovery for the text analysis, in accordance with an embodiment of the present invention.

FIG. 4C presents a flowchart illustrating a method for sentiment analysis for the text analysis, in accordance with an embodiment of the present invention.

FIG. 5 illustrates an exemplary presentation interface, in accordance with an embodiment of the present invention.

FIG. 6 illustrates an exemplary computer and communication system that facilitates surprise analysis in user reviews, in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system, which analyzes surprises in user reviews. Due to ease of access via the Internet, a large number of users provide review about a business entity. Such reviews can include surveys (e.g., regarding customer experience) comprising numerical data (e.g., on the scale of 1-10, how would you rate the cleanliness of the guestroom), and textual comments (e.g., a social media post). However, a review can include a discrepancy. In this disclosure, a review with such a discrepancy can be referred to as a surprise. For example, in the context of a customer experience survey about a service, individual numerical data fields of the survey can indicate a good experience but the survey can have an negative recommend score (e.g., a low likelihood of recommending the service). These surprises usually indicate specific problems, which a business entity can address.

Surprises can offer key insights, such as isolated problems associated with a business entity. Isolated problems are often more informative than multiple coexisting problems, as the former gives a clearer attribution than the latter. For instance, an unsatisfied customer can report a single problem. This is an isolated problem, and a solution to this problem may satisfy this customer and improve his/her experience. On the other hand, if that problem coexists with several other problems, identifying the key factors of customer dissatisfaction becomes harder.

However, with existing technologies, the data mining techniques provide analysis of specific mainstream features (e.g., how a particular feature of the business entity is resonating with the users). As a result, these techniques may fail to recognize the surprises. To solve this problem, embodiments of the present invention provide a system that facilitates detection and analysis of surprises from a large set of user reviews. The system screens a large number of reviews and detects the reviews with surprises (e.g., with significant data discrepancies) based on feature extraction, prediction, and outlier detection. The system then processes the detected surprises using text analytics techniques, such as feature discovery and sentiment analysis, to find insights (e.g., common features and sentiment) into the detected surprises. The system can also provide representative examples based on information retrieval techniques via a presentation interface.

### Surprise Analysis System

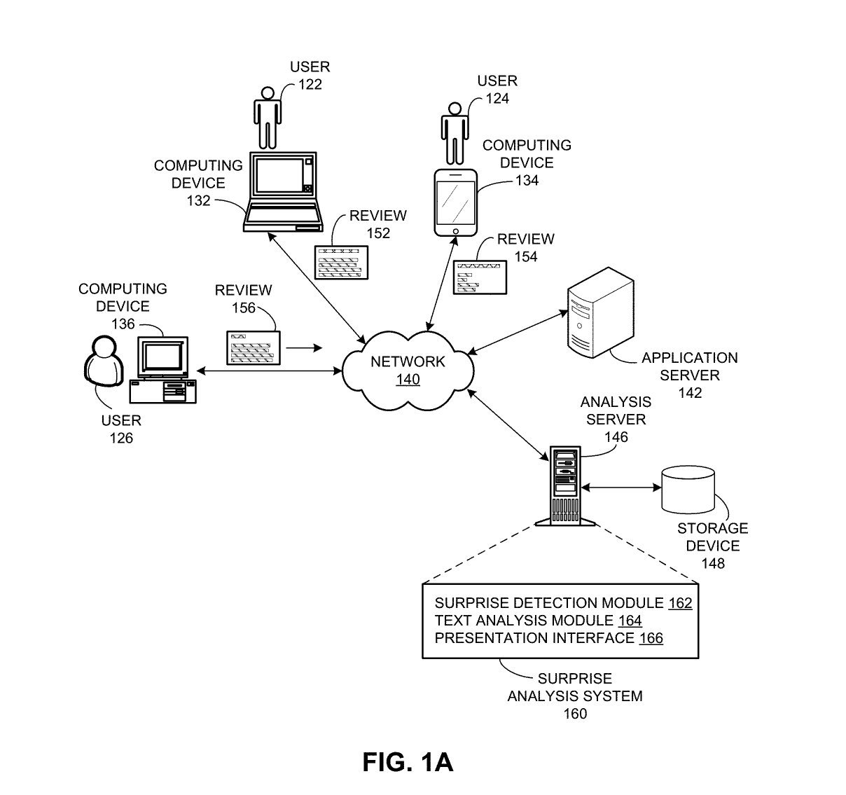

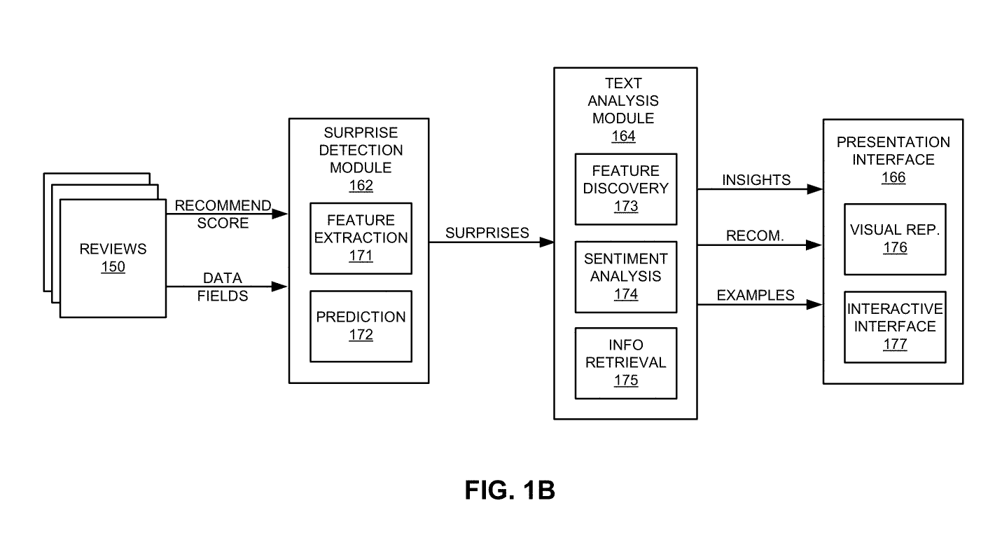

FIG. 1A illustrates an exemplary surprise analysis system, in accordance with an embodiment of the present invention. In this example, a large number of users 122, 124, and 126 of a business entity provide reviews 152, 154, and 156, respectively, about the business entity via a variety of computing devices 132, 134, and 136, respectively. These computing devices are coupled via a network 140, which can be a local or wide area network, to an application server 142 that hosts the review for the business entity. Examples of a review include, but are not limited to, a survey with numerical indicators, a social media post, and a review posted on a website. It should be noted that these reviews can be hosted in different servers associated with the corresponding service.

Typically, a review includes an overall indication whether a user has expressed a positive or negative sentiment in the review. This overall indication can be referred to as a “recommend score” (e.g., how likely the user is going to commend the service of the business entity). If a user expresses a positive “recommend score” in a review (e.g., a 9 or 10 out of 10), the user can be referred to as a “promoter.” On the other hand, if the user expresses a negative “recommend score” in a review (e.g., a 6 or lower), the user can be referred to as a “detractor.” Otherwise, the user can be referred to as a “neutral.” A review can also include opinions about specific features (e.g., for a hotel, the opinion can be about the cleanliness of a guestroom and friendliness of the staff). These opinions can be represented by different data fields in the review.

Suppose that review 152 is an instance of an “expected” review, which indicates that user 122 is a promoter and review 152 has positive opinions about individual features, or user 122 is a detractor and review 152 has negative opinions about individual features. In this example, user 124 is a promoter and review 154 has negative opinions about individual features. Here, based on the negative opinions, review 154 should have indicated user 124 to be a detractor. However, the observed recommend score of review 154 indicates user 124 to be a promoter. Since the opinions of individual features shows significant deviation from the observed recommend score, review 154 can be considered as a surprise. In the same way, review 156 can also be a surprise, where user 126 is a detractor and review 156 has positive opinions about individual features. These surprises can indicate specific problems, which the business entity can address.

However, with existing technologies, the data mining techniques may not be able to recognize surprises 154 or 156 from expected review 152. For example, such a technique may reveal that users 122 and 124 have negative opinions about a specific feature, without detecting that user 124 might be a promoter. To solve this problem, embodiments of the present invention provide a surprise analysis system 160 that facilitates detection and analysis of surprises from a large set of reviews 152, 154, and 156. System 160 can operate on an analysis server 146, which can be a separate computing device, a virtual machine on a host machine, or an appliance. It should be noted that, since a data mining technique running on a generic computing system may not be able to identify the surprises, system 160 improves the functioning of server 146.

During operation, server 146 obtains reviews 152, 154, and 156 from application server 142 and stores these reviews in storage device 148. System 160 includes a surprise detection module 162, which screens a large number of reviews 152, 154, and 156 and detects surprises 154 and 156 based on feature extraction, prediction, and outlier detection. The system also includes a text analysis module 164, which processes detected surprises 154 and 156 using text analytics techniques, such as feature discovery and sentiment analysis, to find insights into surprises 154 and 156. In some embodiments, the system also includes a presentation interface 166, which provides visual representations of the insights and representative examples based on information retrieval techniques.

In some embodiments, system 160 derives whether a user is a promoter based on textual analysis of a review. For example, in a social media post, a user may not numerically express a recommend score. However, based on a textual analysis of the words or word combinations (e.g., “stay again” or “won't go back”), system 160 can determine whether the user is a promoter or a detractor. Similarly, system 160 can derive whether the user's opinion about a particular feature is positive or not based on the textual analysis (e.g., “clean” or “smelly”) and can assign a corresponding feature value.

FIG. 1B illustrates exemplary components of a surprise analysis system, in accordance with an embodiment of the present invention. In this example, surprise detection module 162 obtains recommend scores and the data fields representing the opinions about individual features from a large set of reviews 150. In some embodiments, surprise detection module 162 includes a prediction mechanism 172, which trains a prediction (or clustering) model based on the individual features of the large set of reviews. Surprise detection module 162 can also include a feature extraction mechanism 171, which extracts impactful features from a review. These features are the most indicative of a user's sentiments. Prediction mechanism 172 then predicts a recommend score based on the opinions expressed about those impactful features. Surprise detection module 162 then compares the recommend score of the review with the predicted score, and upon detecting a significant discrepancy, detects a surprise.

Text analysis module 164 obtains the detected surprises and analyzes them for insights. Text analysis module 164 includes a feature discovery mechanism 173, which uses text analytics techniques to determine the features that caused the surprise. Text analysis module 164 also includes a sentiment analysis mechanism 174, which determines the sentiment associated with those features. In this way, text analysis module 164 provides insights (e.g., common features and sentiment) into the detected surprise. Text analysis module 164 can also include an information retrieval mechanism 175, which facilitates interaction with text analysis module 164 by allowing a user to retrieve examples on demand. Information retrieval mechanism 175, in conjunction with presentation interface 166, allows users to retrieve the examples based on a feature (e.g., sentences/surveys associated with a feature) or an example (e.g., sentences/surveys similar to the current example).

In some embodiments, presentation interface 166 obtains the insights and examples from text analysis module 164. Presentation interface 166 can be an interface for a computing device (e.g., a monitor of a desktop or laptop), or an adjusted interface for a cellular (e.g., a cell phone or a tablet) device. Presentation interface 166 includes a visual representation mechanism 176, which presents the insights and sentiments in a graphical or textual representation. Presentation interface 166 can also include an interactive interface 177, which allows the user to use information retrieval mechanism 175 to extract features and examples for a specific feature. In some embodiments, interactive interface 177 also provides recommendations (e.g., from a user's suggestions) associated with a particular feature or example. Examples of a presentation interface include, but are not limited to, a graphical user interface (GUI), a text-based interface, and a web interface.

In this way, surprise analysis system 160 can filter out a few surprises from a large set of reviews 150. For example, surprise detection module 162 filters out surprises from a large number of reviews so that the user workload of reading the surprises stays manageable. Surprise analysis system 160 can further analyze the surprises to provide a handful of insights, which the business entity can address. In addition, based on the detected surprises, the business entity can determine whether important data aspects are captured in a survey.

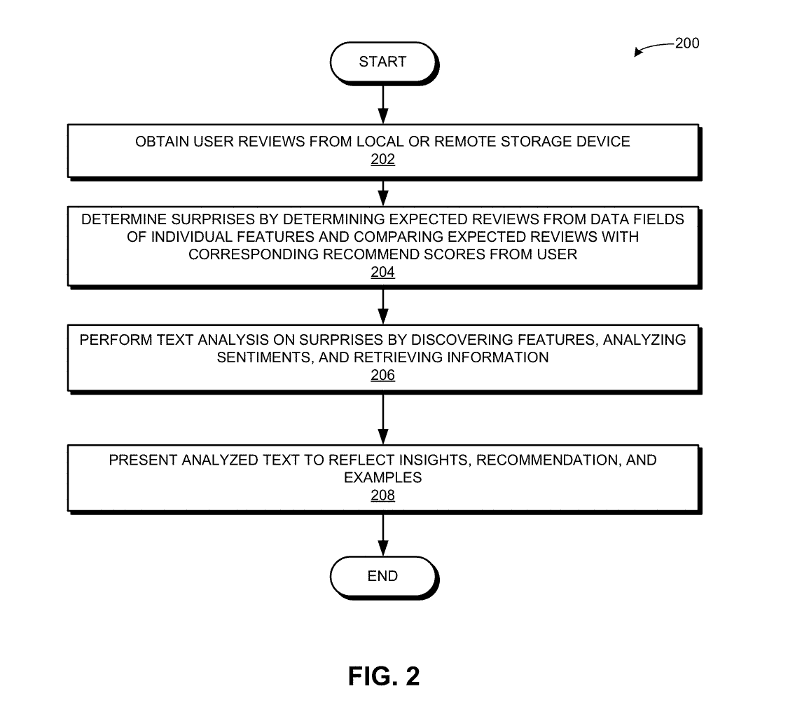

FIG. 2 presents a flowchart 200 illustrating a method for surprise analysis in user reviews, in accordance with an embodiment of the present invention. During operation, a surprise analysis system obtains reviews from a local or remote storage device (e.g., a storage device of a remote application server) (operation 202). The system then determines the surprises by determining expected reviews from data fields representing opinions about individual features and comparing the expected reviews with corresponding recommend scores from the users (operation 204). The system then performs text analysis on the determined surprises by discovering features, analyzing sentiments, and retrieving information (operation 206). The system then presents the analyzed text to reflect insights, recommendations, and examples (e.g., in a presentation interface) (operation 208).

### Surprise Detection

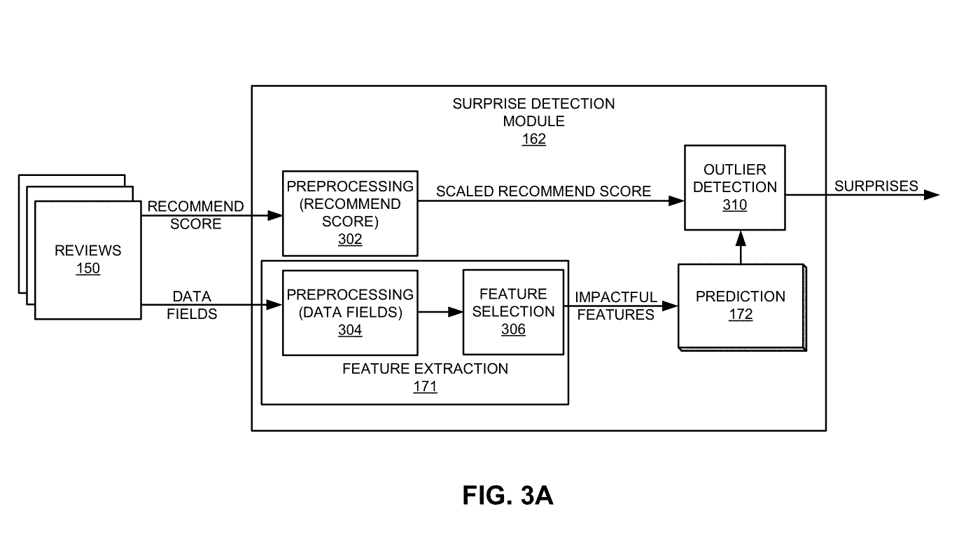

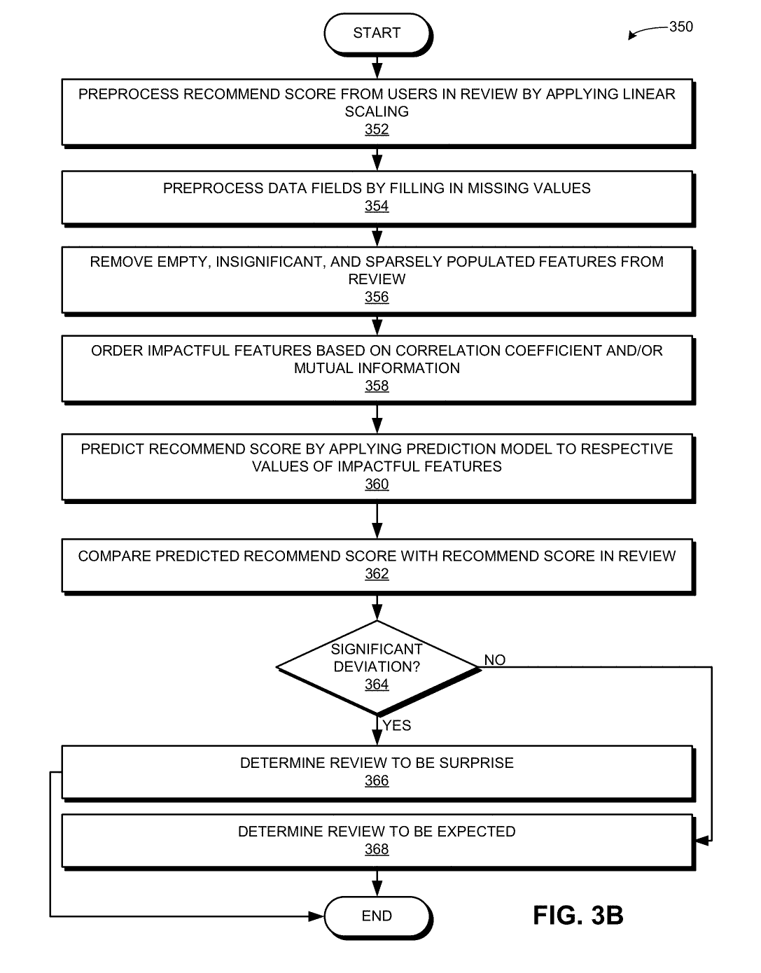

FIG. 3A illustrates an exemplary surprise detection, in accordance with an embodiment of the present invention. In this example, surprise detection module 162 obtains the recommend score and data fields of a respective review of large set of reviews 150. Surprise detection module 162 includes a preprocessing mechanism 302 for the recommend scores from users. These recommend scores determine whether a user is a promoter, detractor, or neutral. Preprocessing mechanism 302 uses a piece-wise linear scaling mapping to represent the recommend scores to a uniform scale. For example, only a small range of high scores (e.g., [8.5, 10]) can indicate a promoter.

On the other hand, a larger range of scores can indicate a detractor (e.g., [0, 6)). Since set of reviews 150 is large, such an uneven range of scores can create a bias for the detractors in the surprise detection process. Preprocessing mechanism 302 thus uses the piece-wise linear scaling mapping to reduce the bias. In some embodiments, the piece-wise linear scaling mapping for the recommend scores is from [0, 10] to [4, 10]. Compressing the overall value range, and in particular, the detractor value range enables a more accurate prediction (e.g., as performed by prediction mechanism 172 of FIG. 1B). In some embodiments, preprocessing mechanism 302 derives whether a user is a promoter based on textual analysis of a review (e.g., a social media post or a review in a website).

Feature extraction mechanism 171 includes a preprocessing mechanism 304 for the data fields representing the opinions about the features. Preprocessing mechanism 304 identifies the missing values for a particular feature (e.g., a question missing an answer in a survey) and can fill in these values. Preprocessing mechanism 304 calculates correlation with other similar users' opinions about the feature (e.g., how other similar users have answered the corresponding survey question). In some embodiments, preprocessing mechanism 304 can derive whether the user's opinion about the feature is positive or not based on the textual analysis. For example, if the review is a social media post for a hotel, preprocessing mechanism 304 can look for specific words associated with a hotel stay (e.g., “cleanliness” and “lobby”).

Feature extraction mechanism 171 also includes a feature selection mechanism 306 for selecting impactful features of a review. In this way, feature selection mechanism 306 facilitates “noise reduction” for the surprise detection. For example, feature selection mechanism 306 removes the features that are empty or insignificant (e.g., can have only one meaningful answer). Feature selection mechanism 306 can also discard the sparsely populated features, which do not have enough data samples (e.g., less than 30% populated). Feature selection mechanism 306 then orders the features based on a correlation coefficient or mutual information associated with the features. This ordering represents the features that are most significant in indicating whether a user is a promoter or a detractor.

Prediction mechanism 172 obtains the ordered impactful features from feature selection mechanism 306 and applies a prediction model, as described in conjunction with FIG. 1B. Examples of a prediction model include, but are not limited to, linear regression, Lasso (least absolute shrinkage and selection operator), and SVR (support vector regression). Prediction mechanism 172 generates a prediction of recommend score based on the opinions expressed about those impactful features. Surprise detection module 162 further includes an outlier detection mechanism 310, which compares the scaled recommend scores from preprocessing mechanism 302 with the corresponding predicted scores from prediction mechanism 172.

If a recommend score deviates significantly from a predicted score of a review (e.g., more than a threshold value), outlier detection mechanism 310 marks that review as a surprise. In some embodiments, system 160 maintains the surprises in a database in storage device 148. System 160 can also have a flag indicating a surprise in the database storing the reviews. In the example in FIG. 1B, to show the surprises to a user, presentation interface 166 retrieves the surprises from the database in storage device 148 in conjunction with information retrieval mechanism 175.

A prediction model can be supervised, where an observed value of a recommend score and respective values of impactful features in a respective review are used to train the prediction model. In some embodiments, system 160 uses unsupervised clustering to compute clusters of the respective values of the impactful features. These values can represent the expected reviews. If system 160 identifies data points away from the clusters, system 160 identifies the review associated with the identified data points as a surprise. Examples of clustering include, but are not limited to, K-means, density-based clustering, spectral clustering, Density-based spatial clustering of applications with noise (DBSCAN), and mixture models.

FIG. 3B presents a flowchart 350 illustrating a method for surprise detection in a review, in accordance with an embodiment of the present invention. It should be noted that flowchart 350 provides an exemplary method for surprise detection based on a supervised prediction-based algorithm. A surprise analysis system can detect surprises using other methods as well. For instance, an unsupervised clustering algorithm can also be used. During operation, the surprise analysis system preprocesses the recommend score for the review from a user (i.e., the observed recommend score) by applying a linear scaling (operation 352). The system also preprocesses the data fields representing the opinions about individual features by filling in missing values (operation 354). The system removes the empty, insignificant, and sparsely-populated features from the review (operation 356) and orders the impactful features (e.g., the rest of the features) based on a correlation coefficient and/or mutual information (operation 358).

The system then predicts a recommend score for a review by applying a prediction model to the respective values of the impactful features (operation 360). The system compares the predicted recommend score with the recommend score in the review (operation 362) and checks whether they have significant deviation (operation 364). If the predicted recommend score significantly deviates from the recommend score in the review, the system determines the review to be a surprise (operation 366). Otherwise, the system determines the review to be consistent (operation 368). It should be noted that if an unsupervised clustering mechanism is used instead of a prediction mechanism, a user review is compared against the identified clusters. If the review is an outlier significantly away from any cluster, the review is detected as a surprise.

### Text Analysis

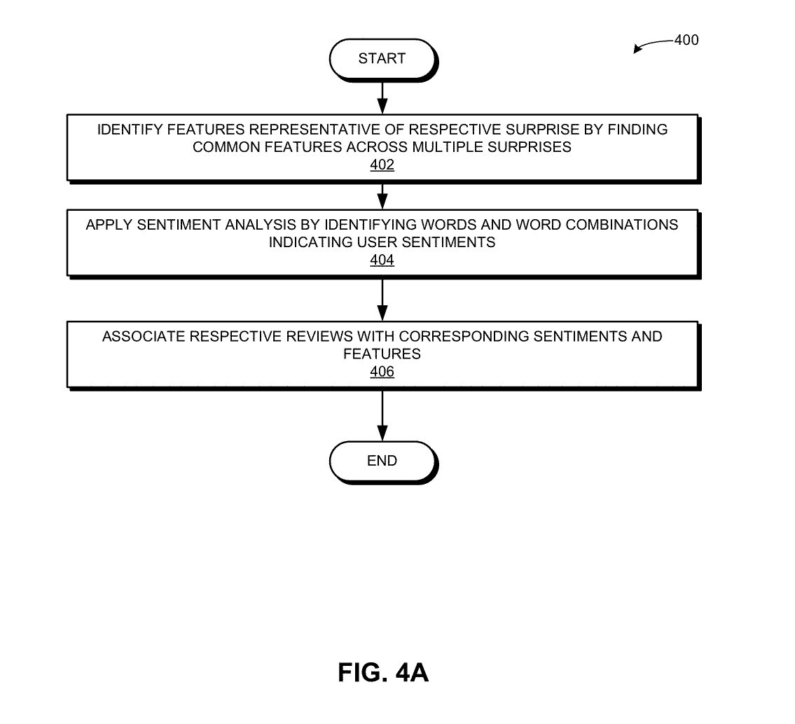

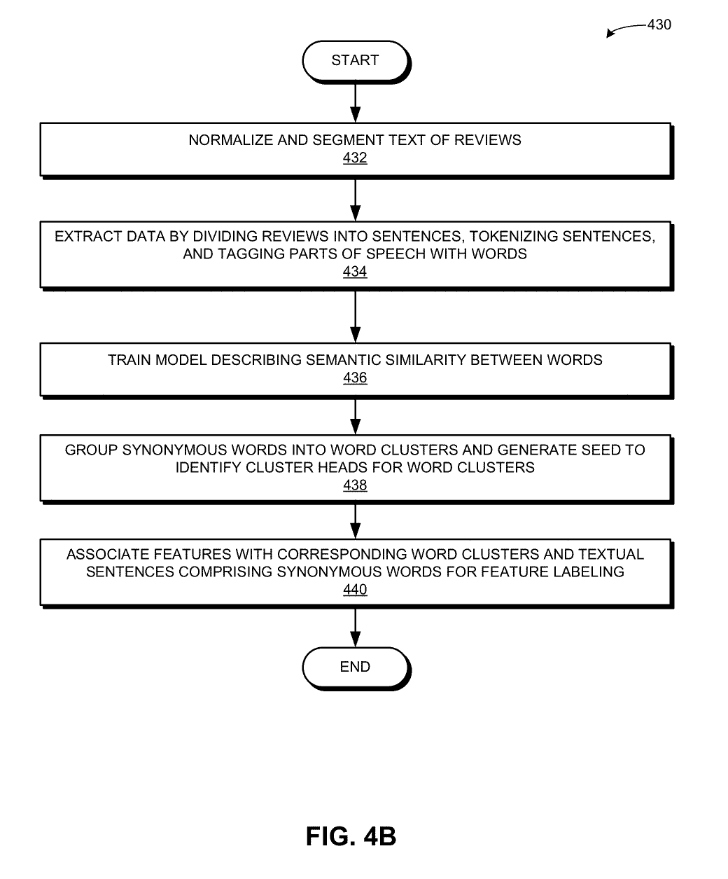

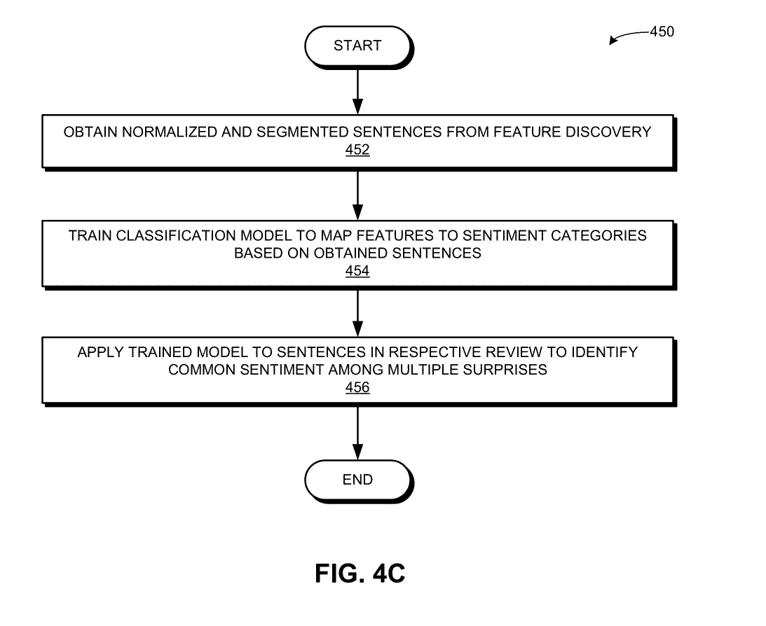

FIG. 4A presents a flowchart 400 illustrating a method for text analysis of surprises in user reviews, in accordance with an embodiment of the present invention. During operation, a surprise analysis system identifies the features representative of a respective surprise by finding the common features across multiple surprises (operation 402). The system then applies sentiment analysis by identifying the words and word combinations identifying user sentiments (operation 404). The system also associates respective reviews with corresponding sentiments and features (operation 406). In this way, the system finds common features across multiple reviews and labels a respective review using a set of features and emotions.

FIG. 4B presents a flowchart 430 illustrating a method for feature discovery for the text analysis, in accordance with an embodiment of the present invention. It should be noted that flowchart 450 provides an exemplary method for feature discovery. A surprise analysis system can discover features using other methods as well. During operation, the surprise analysis system normalizes and segments text of review (operation 432) and extracts data by dividing the reviews into sentences, tokenizing sentences, and tagging parts of speech with the words (operation 434). The system can use data analysis techniques, such as TF-IDF (term frequency-inverse document frequency). The system then trains a model (e.g., word2vec) describing semantic similarity between the words (operation 436).

The system also groups synonymous words into word clusters and generates a seed to identify cluster heads for the word clusters (operation 438). For example, similar words, such as “taxi,” “cab,” “bus,” and “shuttle” can be grouped into a cluster. In the context of the reviews, if the word “taxi” most frequently represents a feature, “taxi” can be selected as the seed and the head for the cluster. Other words, such as “cab,” “bus,” and “shuttle,” can be clustered to the seed. The system then associates features with corresponding word clusters and textual sentences comprising the synonymous words for feature labeling (operation 440). This allows the system to present examples of a feature to a user.

FIG. 4C presents a flowchart 450 illustrating a method for sentiment analysis for the text analysis, in accordance with an embodiment of the present invention. During operation, a surprise analysis system obtains normalized and segmented sentences from the feature discovery (operation 452), as described in conjunction with FIG. 4B. The system trains a classification model (e.g., a supervised model) to map features (e.g., features associated with words, bigrams, trigrams, etc.) to sentiment categories (e.g., positive, negative, no clear opinion, and mixed opinion) based on the obtained sentences (operation 454). The system then applies the trained model to the sentences in a respective review to identify common sentiments among multiple surprises (operation 456).

### Presentation Interface

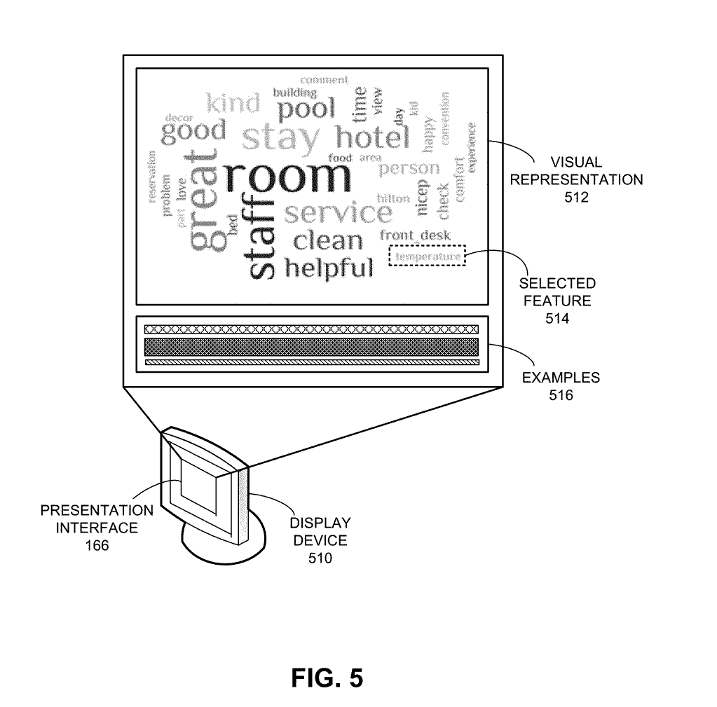

Surprise analysis system 160 uses text analytics methods, such as feature discovery, sentiment analysis, and information retrieval, to obtain insights, such as common features and sentiments from the identified surprises. Surprise analysis system 160 can further ease a user's effort at understanding the surprises by representing them in a presentation interface 166. FIG. 5 illustrates an exemplary presentation interface, in accordance with an embodiment of the present invention. In this example, a display device 510 displays presentation interface 166.

Presentation interface 166 provides a visual representation 512 of the impactful features. Visual representation 512 can be generated by visual representation mechanism 176 and can represent the insights (e.g., emotions) obtained from text analysis module 164, as described in conjunction with FIG. 1B. For example, a feature colored green can indicate a positive overall recommend score (e.g., a mean or median value of recommend score). Similarly, a feature colored red can indicate a negative overall recommend score. Furthermore, if a feature is indicative of a large number of surprises, that feature can appear in a larger font than other features. In the example in FIG. 5, visual representation 512 shows surprises associated with a hotel. The word “room” appears in a larger font than the word “pool.” Here, visual representation 512 indicates that more surprises are associated with room than pool for the hotel.

Presentation interface 166, in conjunction with text analysis module 164 in the example in FIG. 1B, allows a user to retrieve examples on demand. For example, a user can select a feature from visual representation 512 (e.g., by clicking on the feature). Suppose that a selected feature is “temperature.” Upon selection, presentation interface 166 shows one or more examples 516 associated with temperature. These examples can include surprises from both promoters and detractors. Presentation interface 166 can be an interface for a computing device (e.g., a monitor of a desktop or laptop), or an adjusted interface for a cellular (e.g., a cell phone or a tablet) device. Examples of a presentation interface include, but are not limited to, a graphical user interface (GUI), a text-based interface, and a web interface.

### Exemplary Computer and Communication System

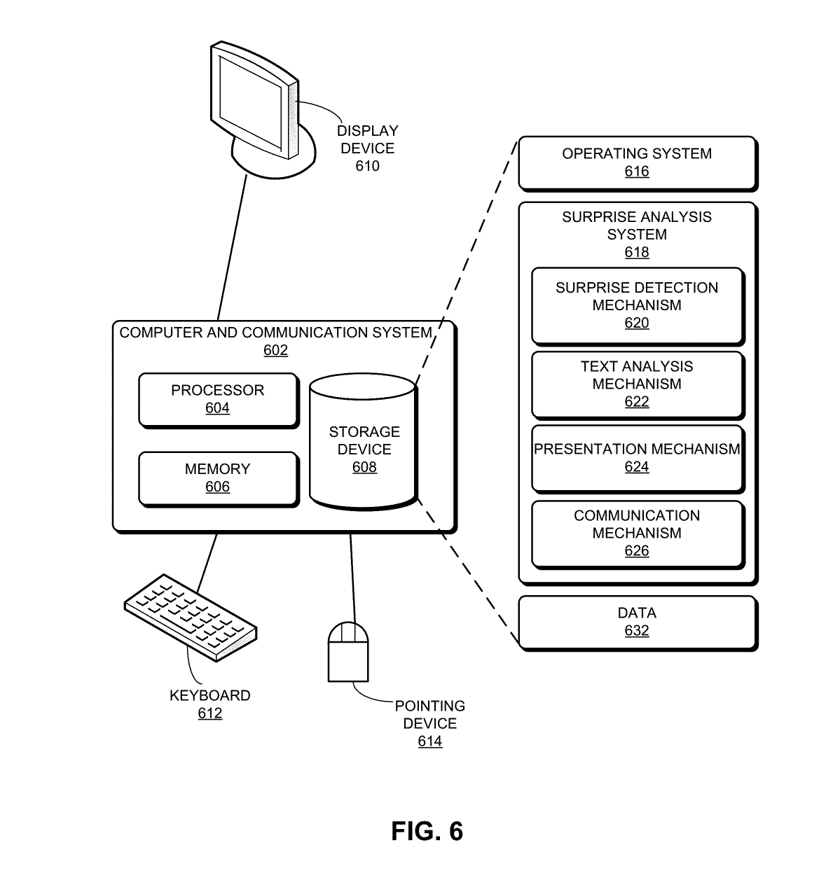

FIG. 6 illustrates an exemplary computer and communication system that facilitates surprise analysis in user reviews, in accordance with an embodiment of the present invention. A computer and communication system 602 includes a processor 604, a memory 606, and a storage device 608. Memory 606 can include a volatile memory (e.g., RAM) that serves as a managed memory, and can be used to store one or more memory pools. Furthermore, computer and communication system 602 can be coupled to a display device 610, a keyboard 612, and a pointing device 614. Storage device 608 can store an operating system 616, a surprise analysis system 618, and data 632.

Surprise analysis system 618 can include instructions, which when executed by computer and communication system 602, can cause computer and communication system 602 to perform the methods and/or processes described in this disclosure. Surprise analysis system 618 further includes instructions for detecting surprises from user reviews (surprise detection mechanism 620). Surprise analysis system 618 can also include instructions for analyzing text in the detected surprises (text analysis mechanism 622). Surprise analysis system 618 can include instructions for presenting the analyzed surprises in a presentation interface (presentation mechanism 624). Surprise analysis system 618 can also include instructions for exchanging information with other devices (communication mechanism 628).

Data 632 can include any data that is required as input or that is generated as output by the methods and/or processes described in this disclosure. Specifically, data 632 can store one or more of: a first database comprising the user reviews, and a second database comprising the surprises. In some embodiments, the first database can include a flag indicating a review to be a surprise.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for surprise analysis in user reviews, the method comprising:
storing, in a storage device, a plurality of user reviews, wherein a user review includes a recommend score indicating a likelihood of recommending, and one or more feature values indicating user opinions about features in the user review;
determining a first user review from the plurality of user reviews to be a first surprise in response to detecting a discrepancy between a recommend score and feature values of the first user review; and
performing a text analysis on the first surprise to discover impactful features in the surprise.

2. The method of claim 1, further comprising:
identifying the impactful features based on a respective importance of features of a respective user review in the plurality of user reviews; and
training a prediction model to predict a recommend score based on feature values of the identified impactful features.

3. The method of claim 2, wherein determining the first surprise comprises determining whether a predicted recommend score deviates from the recommend score of the first user review.

4. The method of claim 2, further comprising, prior to identifying the impactful features, filling in missing values of features of a respective user review in the plurality of user reviews.

5. The method of claim 1, further comprising:
identifying a plurality of surprises from the plurality of user reviews;
clustering synonymous words in the identified surprises into a word cluster; and
associating the word cluster and reviews comprising the synonymous words with a feature of the impactful features.

6. The method of claim 5, further comprising determining a sentiment category for the feature, wherein the sentiment category is one of: positive, negative, no opinion, and mixed opinion.

7. The method of claim 5, further comprising displaying in a presentation interface one or more surprises associated with the feature in response to a user selecting the feature in the presentation interface.

8. The method of claim 1, further comprising:
determining one or more clusters of user reviews from the plurality of user reviews by grouping user reviews with similar feature values; and
identifying outlier user reviews as surprises, wherein the outlier user reviews deviate significantly from the determined clusters.

9. A computer system for surprise analysis in user reviews, the system comprising:
a processor; and
a storage device storing instructions that when executed by the processor cause the processor to perform a method, the method comprising:
storing, in the storage device, a plurality of user reviews, wherein a user review includes a recommend score indicating a likelihood of recommending, and one or more feature values indicating user opinions about features in the user review;
determining a first user review from the plurality of user reviews to be a first surprise in response to detecting a discrepancy between a recommend score and feature values of the first user review; and
performing a text analysis on the first surprise to discover impactful features in the surprise.

10. The computer system of claim 9, wherein the method further comprises:
identifying the impactful features based on a respective importance of features of a respective user review in the plurality of user reviews; and
training a prediction model to predict a recommend score based on feature values of the identified impactful features.

11. The computer system of claim 10, wherein determining the first surprise comprises determining whether a predicted recommend score deviates from the recommend score of the first user review.

12. The computer system of claim 10, wherein the method further comprises, prior to identifying the impactful features, filling in missing values of features of a respective user review in the plurality of user reviews.

13. The computer system of claim 9, wherein the method further comprises:
identifying a plurality of surprises from the plurality of user reviews;
clustering synonymous words in the identified surprises into a word cluster; and
associating the word cluster and reviews comprising the synonymous words with a feature of the impactful features.

14. The computer system of claim 13, wherein the method further comprises determining a sentiment category for the feature, wherein the sentiment category is one of: positive, negative, no opinion, and mixed opinion.

15. The computer system of claim 13, wherein the method further comprises displaying in a presentation interface one or more surprises associated with the feature in response to a user selecting the feature in the presentation interface.

16. The computer system of claim 9, wherein the method further comprises:
determining one or more clusters of user reviews from the plurality of user reviews by grouping user reviews with similar feature values; and
identifying outlier user reviews as surprises, wherein the outlier user reviews deviate significantly from the determined clusters.

17. A non-transitory computer-readable storage medium storing instructions that when executed by a computer cause the computer to perform a method, the method comprising:
storing, in a storage device, a plurality of user reviews, wherein a user review includes a recommend score indicating a likelihood of recommending, and one or more feature values indicating user opinions about features in the user review;
determining a first user review from the plurality of user reviews to be a first surprise in response to detecting a discrepancy between a recommend score and feature values of the first user review; and
performing a text analysis on the first surprise to discover impactful features in the surprise.

18. The storage medium of claim 17, wherein the method further comprises:
identifying the impactful features based on a respective importance of features of a respective user review in the plurality of user reviews; and
training a prediction model to predict a recommend score based on feature values of the identified impactful features.

19. The storage medium of claim 18, wherein determining the first surprise comprises determining whether a predicted recommend score deviates from the recommend score of the first user review.

20. The storage medium of claim 18, wherein the method further comprises, prior to identifying the impactful features, filling in missing values of features of a respective user review in the plurality of user reviews.

21. The storage medium of claim 17, wherein the method further comprises:
identifying a plurality of surprises from the plurality of user reviews;
clustering synonymous words in the identified surprises into a word cluster; and
associating the word cluster and reviews comprising the synonymous words with a feature of the impactful features.

22. The storage medium of claim 21, wherein the method further comprises determining a sentiment category for the feature, wherein the sentiment category is one of: positive, negative, no opinion, and mixed opinion.

23. The computer system of claim 17, wherein the method further comprises:
determining one or more clusters of user reviews from the plurality of user reviews by grouping user reviews with similar feature values; and
identifying outlier user reviews as surprises, wherein the outlier user reviews deviate significantly from the determined clusters.
